(19) United States
(12) Patent Application Publication
(10) Pub. No.: US 2007/0024921 A1
(43) Pub. Date: Feb. 1, 2007

(54) Image forming device and method for the same

(76) Inventor: Yasutoshi Ohta, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/490,192

(22) Filed: Jul. 21, 2006

(30) Foreign Application Priority Data
Jul. 27, 2005 (JP) 2005-216938
Mar. 15, 2006 (JP) 2006-071629

(51) Int. Cl. H04N 1/40

(52) U.S. Cl. 358/448

(57) ABSTRACT

An image forming device for reading a document as first image data and forming an image of the first image data on a recording medium is disclosed. The image forming device includes a reading unit optically reading the document so as to obtain the first image data; an imaging unit taking an image of a user so as to form second image data together with a reading operation of the reading unit; and a storage unit associating and storing the first image data read by the reading unit with the second image data of the user formed by the imaging unit.

### BACKGROUND OF THE INVENTION

1. Field of the Invention

The present invention generally relates to an image forming device and a method for the same including an imaging unit in which image data taken by the imaging unit are utilized so as to realize a more comfortable operating environment.

2. Description of the Related Art

In recent years, in the field of electronic documents, the need for a security mechanism has been increasing. The term “security” here means preventing unauthorized users from operating a device. Conventionally, devices including an authentication system are used in which a user card such as an IC card, a magnetic card, and the like is used. However, there is a problem of losing the user card. Hence, in recent years, there has been a growing interest in effectiveness of biometric identification. Biometric identification is a technology where a person is authorized by using information of a part of his/her body (a biological organ) such as a fingerprint, a voice print, an iris print of the eye pupil and the like. There are many examples of biometric identification having been put to practical use, for example, a control system of an entrance/exit gate. In biometric identification, it is not necessary to be anxious about the possibility of losing a card; however, a psychological load (reluctance) on the user who operates the device is heavy. Further, it is difficult to monitor the user continuously. Moreover, a biometric identification mechanism is not apt to be mounted on a device where the period necessary for the user to operate the device is comparatively long. Accordingly, there has been a growing interest in a security mechanism utilizing facial information. Facial information can be easily obtained by an imaging device such as a camera. In addition, it is possible to monitor the user continuously by devising a position where the device is to be installed. However, in facial identification, the user is sometimes misrecognized. The facial identification method has a disadvantage in that the recognition rate is far lower than that of the fingerprint method and the like.

Japanese Laid-Open Patent Application Publication No. 2004-56712 discloses a document processor including a camera photographing a user, a scanner scanning a document so as to generate a document file, and the like. An image including a user's face is photographed, and thereby image data are generated together with generating the document file. The image data are transmitted together with the document file to a specified destination.

Japanese Laid-Open Patent Application Publication No. 2004-295693 discloses an image forming device comprising a card authorization mechanism of an IC card and the like in which an image of a user is taken by a monitoring camera and stored together with an input document so as to prevent the making of an improper copy and make it easy to search input document images.

However, the above examples of the conventional technology have problems described below.

Japanese Laid-Open Patent Application Publication No. 2004-56712 makes it easy to specify a user who scans a document by thumbnailing images of users. However, this is not aimed at searching the scanned document images. In addition, onsite search (searching operation in the device which scans documents) is not taken into consideration. For example, in the case where a number of document images scanned by a scanner are stored in the document processor, it is not specifically disclosed how to search for a desired document among the stored document images.

Moreover, in Japanese Laid-Open Patent Application Publication No. 2004-295693, authorization cards and images of users are complementarily used so as to improve security and usability. However, since the photographed images themselves are stored in the device, data may be redundant for the purpose of preventing improper use. In addition, there is a risk of easily running out of storage due to redundant data. Further, it is not specifically disclosed how the images of the users are used for searching documents.

Accordingly, it is not possible to eliminate the problems by using the conventional technology.

### SUMMARY OF THE INVENTION

It is a general object of the present invention to provide an image forming device that substantially obviates one or more problems caused by the limitations and disadvantages of the related art.

It is another and more specific object of the present invention to provide an image forming device and a method for the same including an imaging unit, by which a more comfortable operating environment can be realized.

To achieve these and other advantages in accordance with the purpose of the invention, an embodiment of the invention provides an image forming device for reading a document as first image data and forming an image of the first image data on a recording medium, which image forming device includes a reading unit optically reading the document so as to obtain the first image data; an imaging unit taking an image of a user so as to form second image data together with a reading operation of the reading unit; and a storage unit associating and storing the first image data read by the reading unit with the second image data of the user formed by the imaging unit.

According to at least an embodiment of the present invention, a method of forming an image by reading a document as first image data and recording the first image data on a predetermined recording medium is disclosed, which includes the steps of: reading the document optically so as to obtain the first image data; taking an image of a user so as to form second image data together with a reading operation of the document reading step; and associating and storing the first image data of the document read by the reading unit with the second image data of the user taken by the imaging unit.

According to an aspect of the embodiment of the present invention, the image forming device includes an imaging unit and uses an image taken by the imaging unit so as to realize a more comfortable operating environment.

### BRIEF DESCRIPTION OF THE DRAWINGS

Other objects and further features of the present invention will become apparent from the following detailed description when read in conjunction with the accompanying drawings, in which:

FIG. 1 is a view illustrating an appearance of an image forming device according to a first embodiment of the present invention;

FIG. 2 is a block diagram illustrating a control structure of the image forming device according to the first embodiment of the present invention;

FIG. 3 is a front view illustrating an example of a part of a display/input unit of the image forming device according to the first embodiment of the present invention;

FIG. 4 is a flowchart illustrating operations of the image forming device according to the first embodiment of the present invention;

FIGS. 5A through 5C are examples of images taken by a camera module of the image forming device according to the first embodiment of the present invention;

FIG. 5A shows the image in a normal status;

FIG. 5B shows the image in an undetected status;

FIG. 5C shows the image in a detected status;

FIG. 6 is a front view illustrating an example of displaying a history of images on a touch panel of the image forming device according to the first embodiment of the present invention;

FIG. 7 is a front view illustrating an example of displaying an alert message on the touch panel of the image forming device according to the first embodiment of the present invention;

FIG. 8 is a block diagram illustrating a control structure of the image forming device according to a second embodiment of the present invention;

FIG. 9 is a front view illustrating an example of displaying a request message for user authorization on a touch panel of the image forming device according to the second embodiment of the present invention;

FIG. 10 is a front view illustrating an example of displaying a menu screen exclusive for a user on the touch panel of the image forming device according to the second embodiment of the present invention;

FIG. 11 is a front view illustrating an example of displaying a history of images on the touch panel of the image forming device according to the second embodiment of the present invention;

FIG. 12 is a front view illustrating an example of displaying an alert message on the touch panel of the image forming device according to the second embodiment of the present invention; and

FIG. 13 is a front view illustrating a blacked out status of the touch panel of the image forming device according to the second embodiment of the present invention.

### DESCRIPTION OF THE PREFERRED EMBODIMENTS

In the following, embodiments of the present invention are described with reference to the accompanying drawings.

### First Embodiment

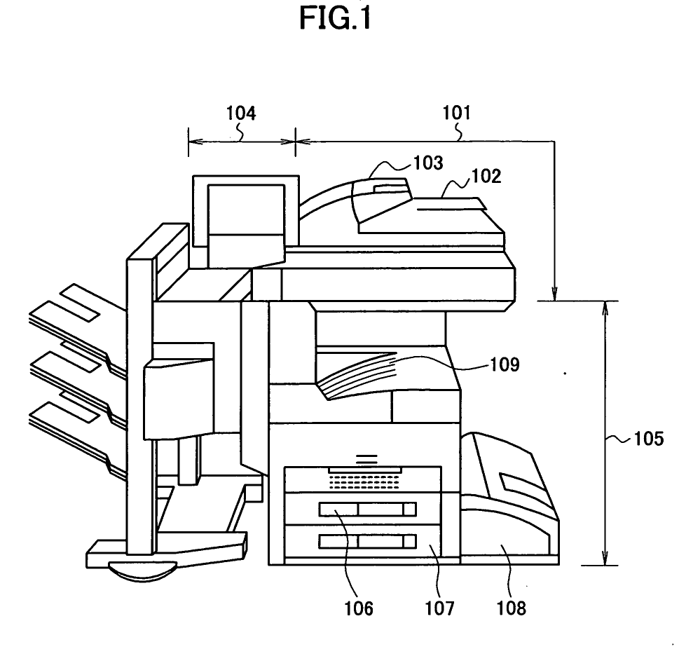

FIG. 1 is a view illustrating an appearance of an image forming device including a copier. A scanner 101 as an image input device illuminates an image on a sheet as a document with light, and scans a CCD line sensor (not shown) so as to generate raster image data. When a user sets a document on a tray 103 of a document feeder 102 and inputs an instruction for scan operations by an operations panel 104, a controller CPU of the image forming device gives an instruction to the scanner 101 so that the document feeder 102 feeds documents one by one, and the scanner 101 scans the documents. The operations panel 104 is a user interface for giving instructions upon forming an image, displaying the status, and specifying operational settings.

A printer engine 105 as an image output device is a portion forming an image of the raster image data on the sheet. Any one of various methods is applicable, for example, an electrophotographic method utilizing a photosensitive drum and a photosensitive belt, an inkjet method printing an image directly on a sheet by squirting ink from a micro-nozzle array, or the like. It should be noted that the printing operation is started by an instruction from a controller CPU.

The printer engine 105 includes plural paper feeders so as to select a different sheet size or a different direction of a sheet, and paper cassettes 106, 107 and 108 corresponding to the paper feeders. A paper catch tray 109 is provided for receiving a sheet on which printing is completed.

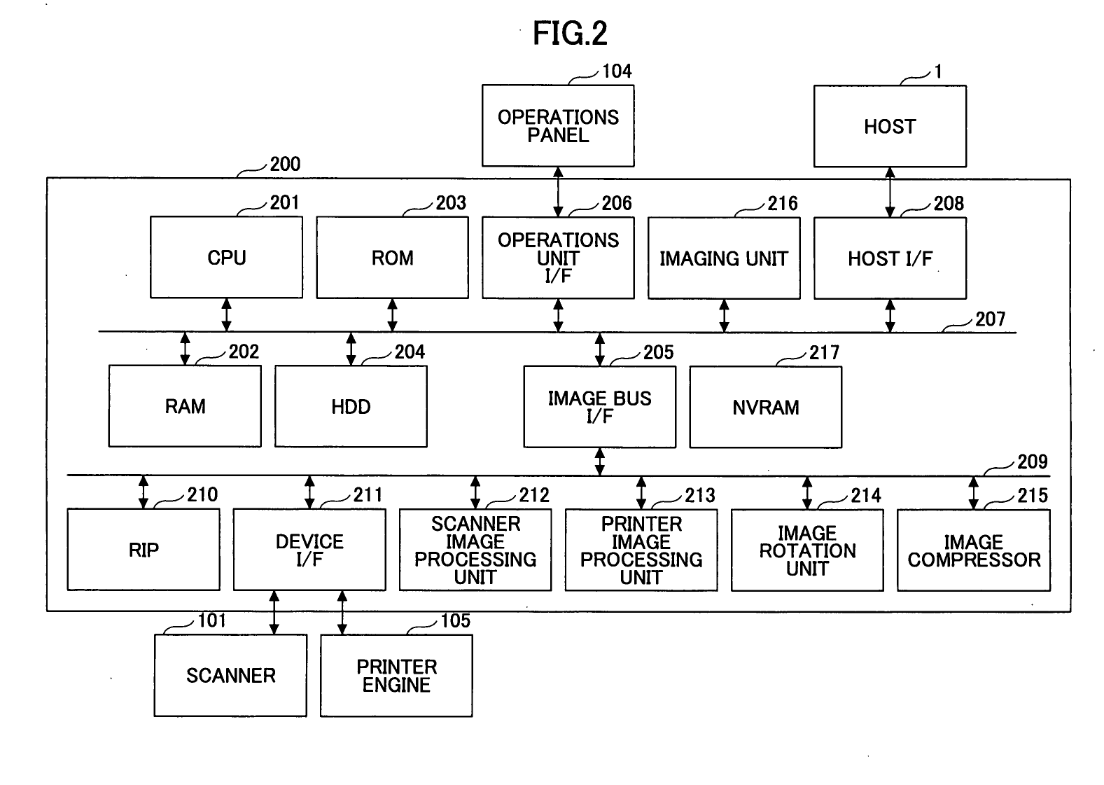

FIG. 2 is a block diagram illustrating a control structure of the image forming device. The printer controller 200 includes a CPU 201, a RAM 202, a ROM 203, an HDD 204, an image bus interface (I/F) 205, an operations unit interface (I/F) 206, a system bus 207, a host interface (I/F) 208, an image bus 209, a raster image processor (RIP) 210, a device interface (I/F) 211, a scanner image processing unit 212, a printer image processing unit 213, an image rotation unit 214, an image compressor 215, and an imaging unit 216. The printer controller 200 is configured to be connected to the scanner 101 as the image input device and the printer engine 105 as the image output device. On the other hand, the printer controller 200 is further configured to exchange printing data, image information, and device information with a host 1 via the host I/F 208.

The CPU 201 is a controller controlling an entire system. The RAM 202 is a work memory in which the CPU 201 operates. Further, the RAM 202 also plays a function as an image memory for temporarily storing the image data. The ROM 203 as a boot ROM stores a system boot program. The HDD 204 as a hard disk drive stores system software and the image data.

The operations unit I/F 206 as an interface between the printer controller 200 and the operations panel 104 outputs image data to be displayed on the operations panel 104 to the operations panel 104. Further, the operations unit I/F 206 plays a function of transmitting information to the CPU 201, which information is input by the user via the operations panel 104. The NVRAM 217 as a nonvolatile memory stores configuration information such as an operating mode input via the operations panel 104.

The host I/F 208 exchange information with the host 1. The CPU 201, the RAM 202, the ROM 203, the HDD 204, the image bus I/F 205, the operations unit I/F 206, the host I/F 208, and the NVRAM 217 are arranged on the system bus 207. The image bus I/F 205 connecting the system bus 207 with the image bus 209 that transmits the image data at high speed is a bus bridge converting a data structure.

The RIP 210, the device I/F 211, the scanner image processing unit 212, the printer image processing unit 213, the image rotation unit 214, and the image compressor 215 are arranged on the image bus 209. The RIP 210 expands PDL code transmitted via the network into a bitmap image. The device I/F 211 connects the printer controller 200 with the scanner 101 as an image input device or the printer engine 105 as an image output device so as to perform synchronous/asynchronous conversion on the image data.

The scanner image processing unit 212 performs correction, processing, and editing on the input image data. The printer image processing unit 213 performs correction of the printer, conversion of the resolution, and the like for the output image data to be printed. The image rotation unit 214 rotates the image data. The image compressor 215 performs JPEG compression/expansion on the multi-value image data. On the other hand, the image compressor 215 performs compression/expansion according to JBIG, MMR, MH, and the like on the binary image data.

The imaging unit 216 arranged on the operations panel 104 of FIG. 1 photographs the user and stores the photo of the user as the image data when the user operates the operations panel 104.

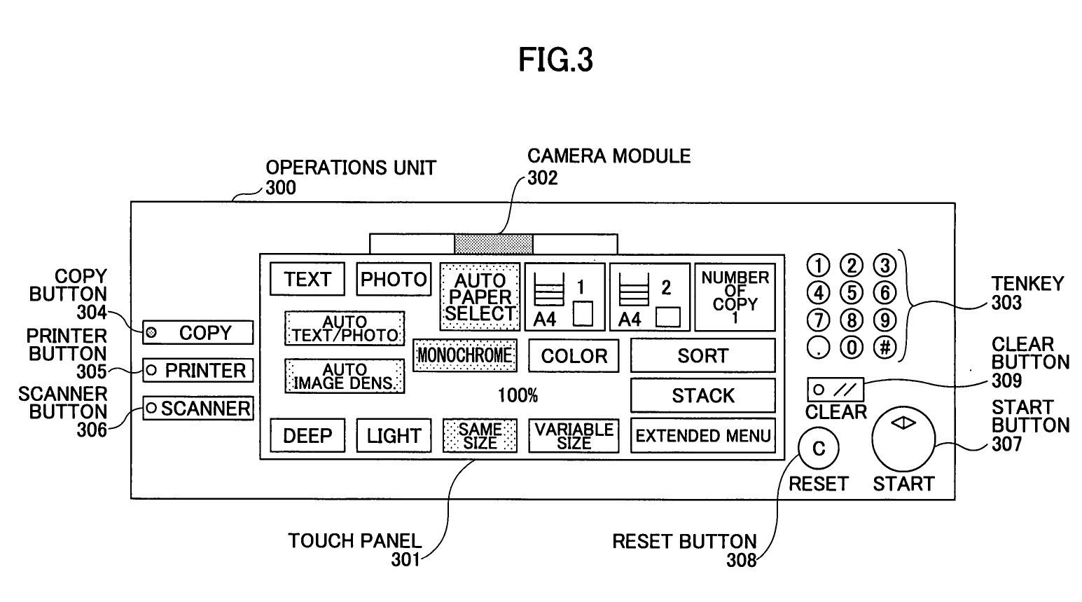

The imaging unit 216 shown in FIG. 2 is arranged as a camera module 302 above the touch panel 301 on the operations unit 300 shown in FIG. 3 so as to photograph the user facing the operations panel 104 of FIG. 1. The operations unit 300 comprises, in the same manner as a normal copier, a ten key 303, a copy button 304, a scanner button 305, a printer button 306, a start button 307, a reset button 308, a clear button 309, the touch panel 301 and the like. It should be noted that in the present specification, the word “user” means “an operator who operates the image forming device”.

In the image forming device according to the present embodiment, in order to read the document using the scanner 101 and store the document as image data, first, the user pushes down the scanner button 305 to select a scanner mode, and then selects the size of the document, resolution of the document upon reading the document, monochrome or color, and the like. Then, the user sets the document on the scanner 101 and pushes down the start button 307 so that the scanner 101 starts reading one page of the document. After the scanner 101 completes reading the document, the HDD 204 shown in FIG. 2 stores the read out image data.

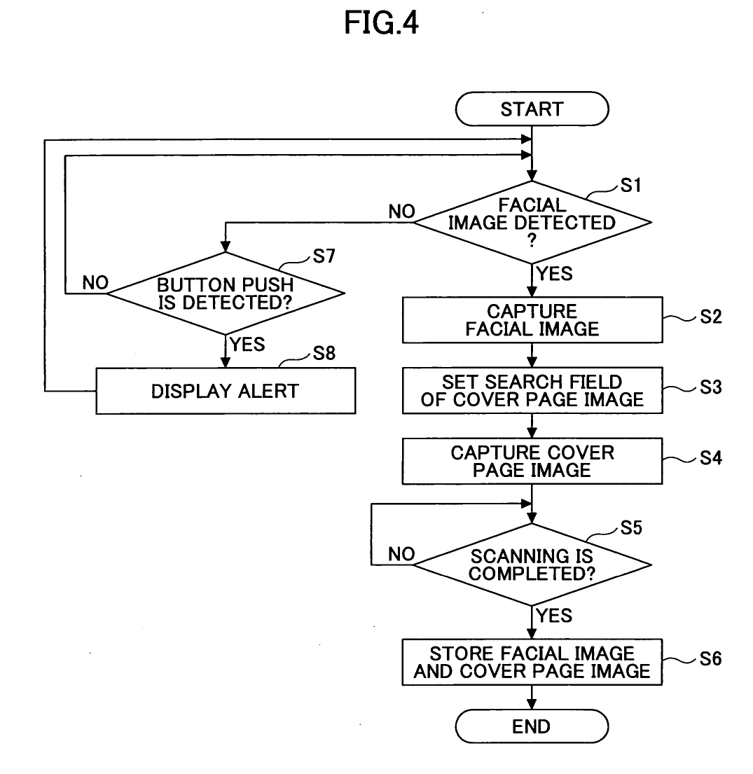

A description is given of the operations of the image forming device according to the present embodiment with reference to FIG. 4.

First, the CPU 201 detects the facial image of the user from the photographed image by the camera module 302 (Step S1). In the case where the facial image (or a figure) of the user is detected (YES in Step S1), the facial image photographed by the camera module 302 is captured (Step S2). Next, the CPU 201 sets a search region of a cover page image of the document (Step S3), and captures the cover page image (Step S4). Then, the CPU 201 determines whether the reading of the document is completed (Step S5). If the reading of the document is completed (YES in Step S5), the facial image and the cover page image are associated with the image data obtained by scanning and stored in the HDD 204 (Step S6).

In Step S1, in the case where the facial image (or the figure) of the user is not detected from the photographed image data (NO in Step S1), the CPU 201 detects whether a predetermined operation such as pressing of the start button 307 is performed by the user (Step S7). In the case where the predetermined operation is performed in the operations unit 300 (YES in Step S7), the CPU 201 displays an alert on the touch panel 301 so that the camera module 302 photographs a face of the user (Step S8).

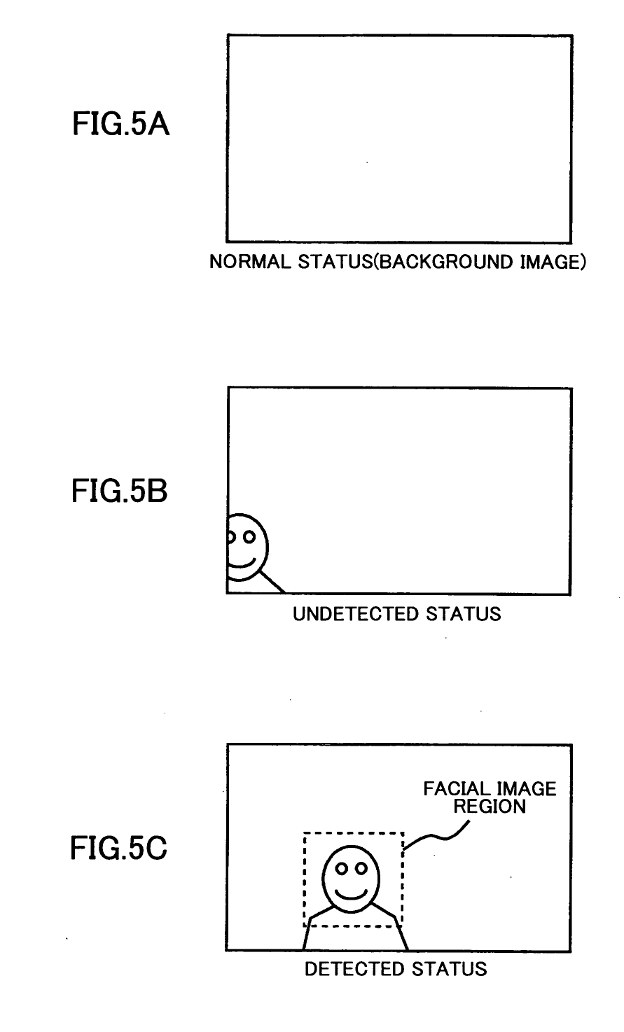

Differences between the document processor according to the embodiment of the present invention and the conventional document processor are in automatically obtaining the facial image of the user and a cover page image of the document by the camera module 302, and storing and accumulating the facial image and the cover page image of the document together with the image data scanned by the scanner 101 in the HDD 204. The images photographed by the camera module 302 are shown in FIGS. 5A through 5C.

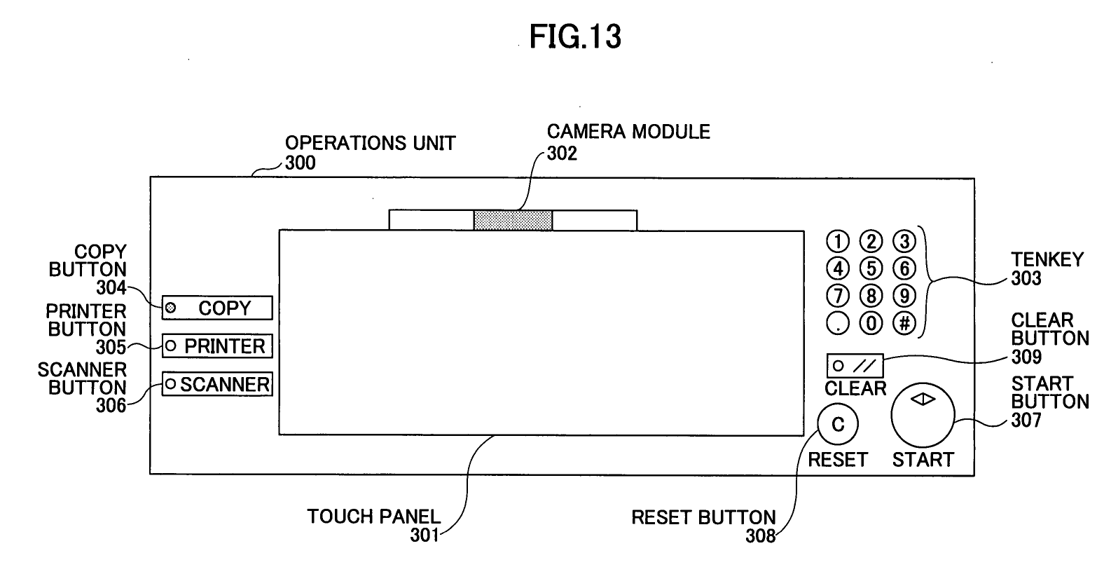

FIG. 5A is a background subtraction image on which, ideally, nothing is shown. At this moment, in the image forming device, the touch panel 301 below the camera module 302 is blacked out in a hibernation status as shown in FIG. 13. As the user approaches the image forming device (“undetected status” as shown in FIG. 5B) so that the camera module 302 detects the face of the user at a size greater than a predetermined size (“detected status” as shown in FIG. 5C), the touch panel 301 is returned to the status as shown in FIG. 3 so that the user can perform operations via the touch panel 301. At the same time, the facial image region is cut out and stored.

In FIG. 5B, since the user is still approaching the image forming device, the camera module photographs only a part of the facial region. Hence, FIG. 5B shows a status in which the face is not detected as the facial image. The facial image and the cover page image of the document may be obtained by monitoring the status in which the user having the document in his/her hand (or arm) approaches the image forming device, and then cutting out the facial image and the document image from the image taken by the camera module 302. The timing when the facial image is cut out may be determined by the system accordingly. For example, only the first detected facial image (shown in FIG. 5C) may be stored. Alternately, the facial images may be consecutively stored while tracing the facial image, and after the facial images are stored, the stored facial images may be evaluated according to a size of the face so as to select one of the most favorable facial images. Then, the other facial images remaining may be deleted.

The cover page image of the document may be obtained upon storing the facial image by recognizing letters or a rectangular field from the image data except for a facial image region and a background region. Accordingly, the image is cut out automatically by the system so that the normal operations by the user are not prevented.

As for the facial image cut out from the image data, since the camera module 302 is provided proximate to the touch panel 301, it is possible to photograph a large sized facial image to some extent. However, a position or a size of the facial image is not always the same. For example, there are cases of not only the facial image viewed from the front, but also the perspective facial images, or profile images being automatically obtained. However, it is not an object of the present embodiment to authorize the user, but to provide a person with information to determine who may make an instruction of scanning the document. A preferred experiment clarifies that a person may demonstrate his/her ability in identifying the user and searching the document even under such an uneven photographing condition, since he/she is excellent in recognizing a facial image. As described above, according to a preferred embodiment of the present invention, each time the user operates the image forming device so as to scan the document, the facial image of the user is photographed again. Accordingly, in comparison to a system in which facial information of the user is registered in the image forming device in advance so as to display the predetermined facial information, it is possible to reflect variation of the user's face with time. With this system, information such as hairstyle, length of the hair, presence/absence of an accessory, a beard, or the like of the same user can be reflected so that it is possible to provide opportunities for the users themselves to recognize the time when the scanning operation is being performed.

On the other hand, the cover page image of the document is automatically cut out by the system in the same manner as the facial image. Hence, it is very rare that the entire image of the cover page of the document is photographed. In most cases, the cover page image of the document is photographed in an inclined status. In addition, there are many cases where only a part of the cover page of the document is checked due to obstacles (for example, a part of the user's body such as a hand or an arm). Even under such a poor condition of photographing, for example, the cover page of the magazine document includes a variety of layouts and color arrangements in each issue so that it is effective for a user to remember what the document is with a view of the cover page.

As for the first page of the document image, in the same manner as the cover page of the document, since the first page is iconized (displayed as an icon), it is not possible to make out what is written by small letters on the first page, but it is possible to recognize whether the document is text data or picture image data. Also, although the entire document image is text data, it is possible to recognize at least layout information thereof. Hence, it is effective in recognizing what the document is.

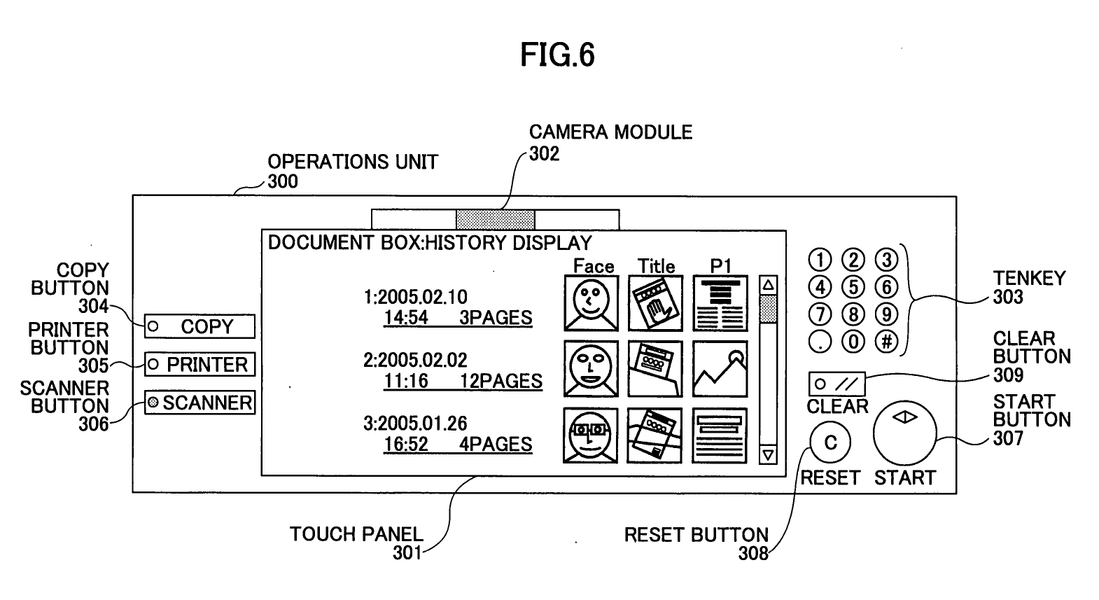

In this way, the image data scanned by the scanner 101 are stored in the HDD 204 of the image forming device so that it is possible to read out the image data according to need. FIG. 6 is a view illustrating an example of a cumulative history of the document image scanned by the scanner 101 in the scanner mode. In FIG. 6, the touch panel 301 shows the three latest images scanned by the scanner 101. The touch panel 301 further shows the facial image (Face) and the image of the cover page of the document (Title) automatically obtained by the camera module 302, and the first page (P1) of the document scanned by the scanner 101, respectively iconized and arranged in a horizontal line.

The user refers to the icons by scrolling up and down the screen of the touch panel 301 so as to search for the desired image data and print them accordingly. In the conventional technology, when searching the image data scanned by the scanner 101 and accumulated by the user him/herself, the information to be a search condition is only a time stamp (time and date), and the number of pages of the scanned document. In the present embodiment, however, in addition to the above information, the facial image of the user who performed the scanning, the image icon of the cover page of the document, and the image icon of the first page of the document may be used as additional information (identification information).

Accordingly, in the present embodiment, upon searching the image data of the document scanned by the user, first, with the facial image icon, it is possible to refine the search to only the image data which have been scanned by the user him/herself. Further, with the image icons of the cover page and the first page, the user can specify the desired document image data more quickly.

Moreover, in the present embodiment, even under a condition in which a large amount of the image data of the document scanned by the scanner 101 are accumulated, it is possible to search out (locate) the desired document in a reduced period since the image data can be distinguished by the above described icons. Further, the image data of the scanned document and the user who scanned the document are associated and stored. Accordingly, as a side benefit, prevention of unauthorized scanning (for example, reading a classified document) can also be expected.

It should be noted that in the present embodiment, the facial image icon is used as the image information for identifying the user; however, the image information is not limited to the facial image icon. For example, an image of an upper half body of the user, or an image of the entire body of the user may be used instead of the facial image icon. Accordingly, it is possible to use information such as clothing, items of the user upon scanning the document by the scanner as a key in searching for the document.

Furthermore, in the present embodiment, as shown in FIG. 6, all the document images are displayed in historical order. The image forming device may be configured to further include a facial image similarity determination unit (not shown) to compare the facial image of the user taken by the camera module with the cumulative facial images photographed in the past so as to display only the facial image icons similar to the facial image of the user and the documents corresponding to the facial image icon. Accordingly, even if the number of the accumulated documents is extremely large, the documents are automatically filtered by the facial image of the user so as to reduce the number of documents to be displayed to a large extent. Further, the user has an advantage of searching for a desired document from the documents accumulated in the past by photographing the facial image. There are already many embodiments of a similar facial image searching technology in which similarity of facial images is calculated from positions of characteristic points on parts such as eyes, mouth, and nose, and a position of a singular point such as a mole. In the present embodiment, it is a premise that the facial images are finally viewed by a person so as to be identified. Accordingly, it is more preferable that the image forming device be configured to exclude facial icons and documents associated with the icons which are clearly different from those of the user than to selectively display only facial icons which are the most similar to the user. That is, the facial icons of the other users and the documents associated with the facial icons which other users resemble the user may be included.

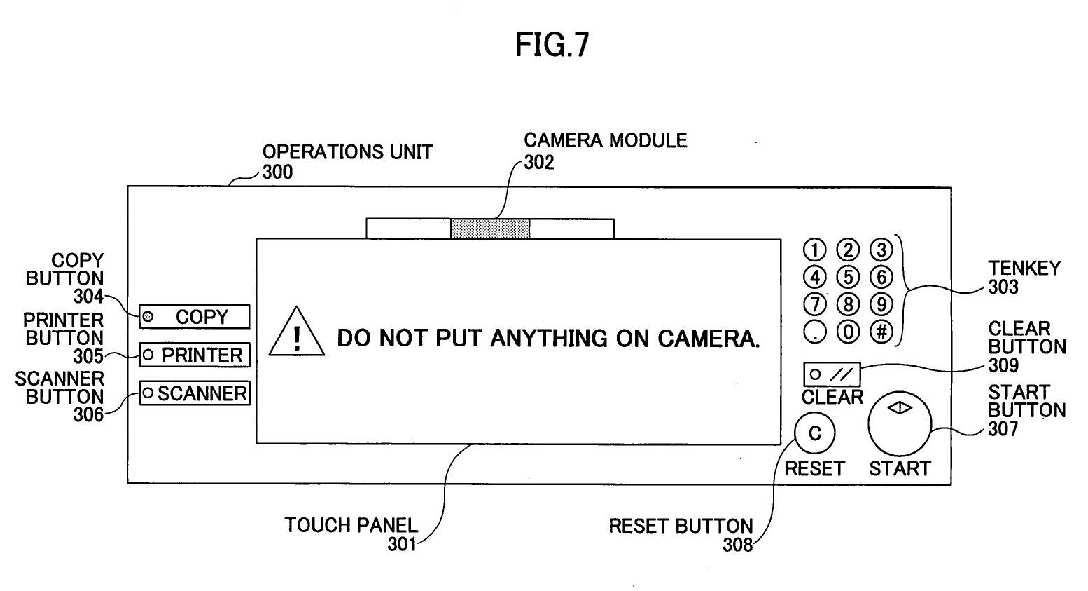

In the above description, the facial image is obtained by the camera module 302 without fail, but it is conceivable that the facial image may not be obtained. One conceivable case is that something is put on the camera module 302 so that it is impossible to photograph the image itself. In this case, the user attempts to push the touch panel or the start button in a status where the facial image is not obtained (see Step S7 in FIG. 4). In this status, a sensor provided on the imaging unit determines that the facial image cannot be recorded, and thus displays an alert as shown in FIG. 7 on the touch panel 301 (see Step S8 in FIG. 4) so as to instruct the user to return to the status in which the camera module 302 can photograph the image again. The CPU 201 is controlled not to receive any operation via the operations unit 300 until the device is returned to a status where the facial image can be detected again.

Moreover, as for another case where the facial image cannot be photographed, it is conceivable that the user hides his/her face intentionally, or the user attempts to operate the device out of the photographic range of the camera module 302 (for example, from the edge-on). In these cases, it is possible to direct the user to return the device to the status where the facial image can be photographed again by displaying an alert on the touch panel 301. It is desirable to display not the alert as shown in FIG. 7 but an alert corresponding to the situation. For example, in the case where the button push is detected even when the camera module 302 obtains an image equivalent to the image (background image) in the normal status as shown in FIG. 5A, it is conceivable that the operation is made from the edge-on. Hence, it is desirable to display an alert such as ‘Operate the device from the front’ on the touch panel 301.

### Second Embodiment

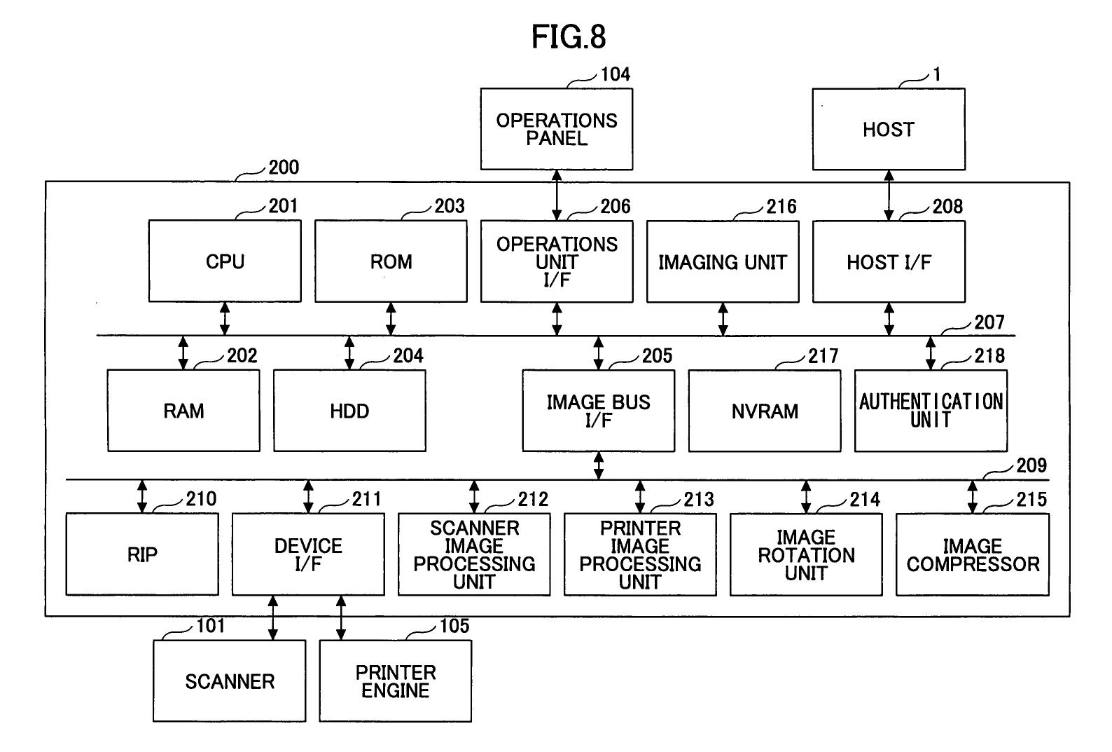

FIG. 8 is a view illustrating an entire image forming device according to a second embodiment of the present invention. The image forming device of the present embodiment shown in FIG. 8 differs from that of the first embodiment shown in FIG. 2 in further including an authentication unit 218 for authorizing a user by a card reader and a user card for authorizing the user. As for the components having the same reference numerals as FIG. 1, an overlapping description thereof is omitted. The present embodiment differs from the first embodiment in that the facial image of the user is not obtained so that the facial image is neither associated with the scanned image data nor accumulated. This is because the user is authorized by the authentication unit 218 in the present embodiment. Hence, it is possible to display and print only the documents scanned by the user him/herself with the image forming device. Accordingly, it is not necessary to use the facial image icon of the user as in the first embodiment. Instead, in the present embodiment, the camera module 302 monitors the presence/absence of the facial image of the user continuously so as to function as a publicly known human detection sensor.

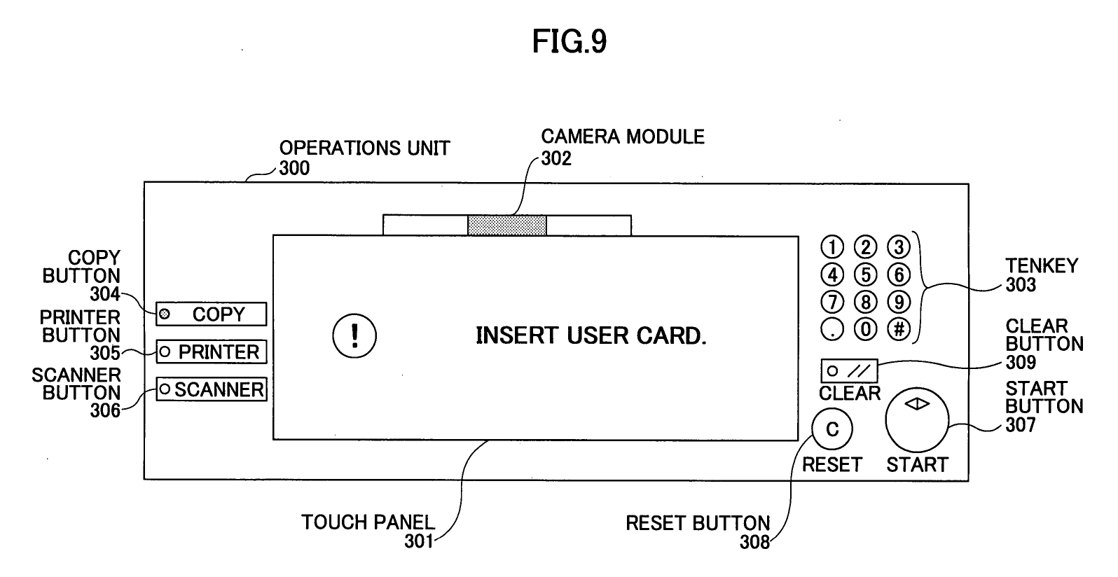

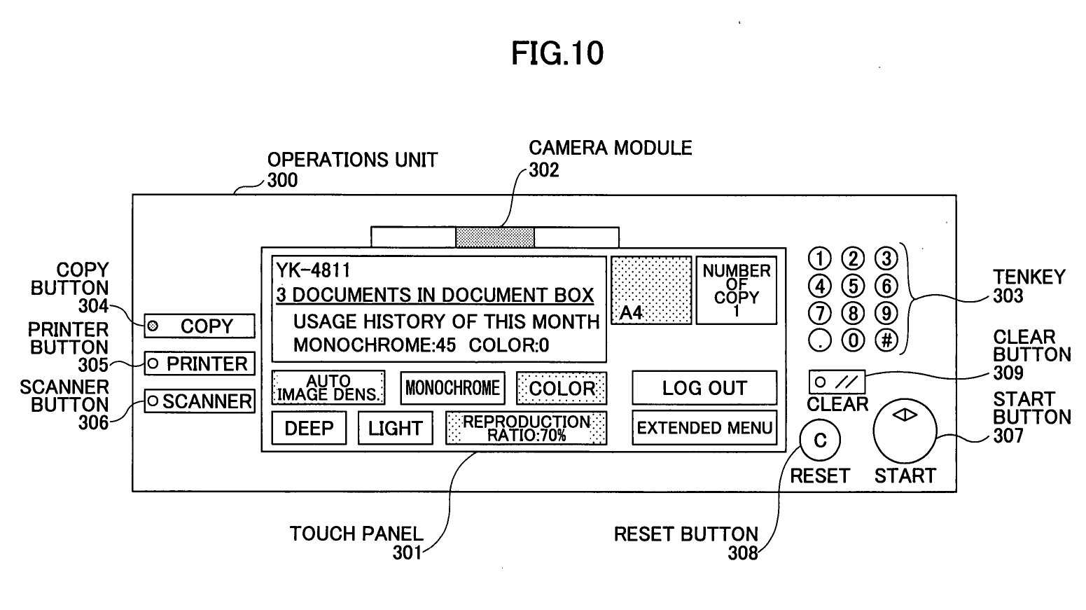

As for the order of the processes, the present embodiment differs from the first embodiment in performing a user authorization first by utilizing a user card. In the initial state, as shown in FIG. 9, a message requesting the user to insert his/her user card is displayed on the touch panel 301. As the user inserts his/her user card into the authentication unit 218, the user is authorized. In a normal operation, since the facial image can be detected without fail by the camera module 302, first, the presence/absence of the facial image is checked by the system. Then, the user is authorized by using the user card. Thus, the touch panel 301 displays a menu screen exclusively for the user as shown in FIG. 10.

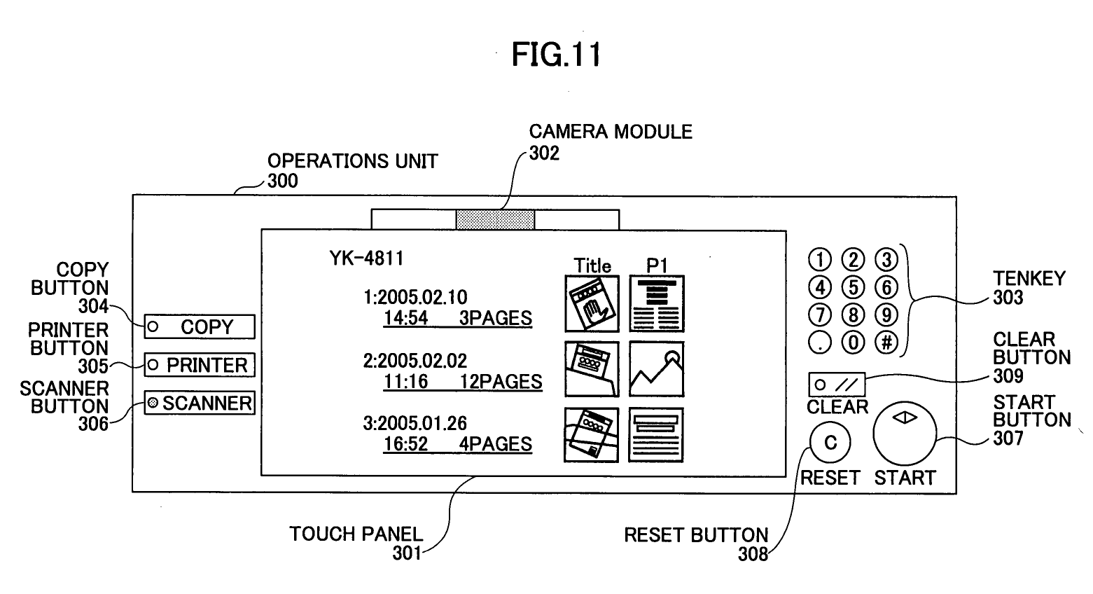

FIG. 10 is a view illustrating the operations unit 300 after the user authorization, which shows there are three image data sets of documents stored in the HDD 204. In the case of scanning and storing the documents according to the scanner 101, the user calls a scanner mode by pushing the scanner button 306, and performs predetermined operations. Here, as an example, as the user touches a sentence (the underlined sentence in FIG. 10) on the touch panel 301 so as to access the stored image data, the screen is switched to the image shown in FIG. 11. The difference between FIG. 6 of the first embodiment and FIG. 11 of the present embodiment is presence/absence of the facial image icon. The first page and the cover page of the document scanned by the scanner 101 are displayed in the same manner as in the first embodiment. Further, the same effect can be obtained as the first embodiment.

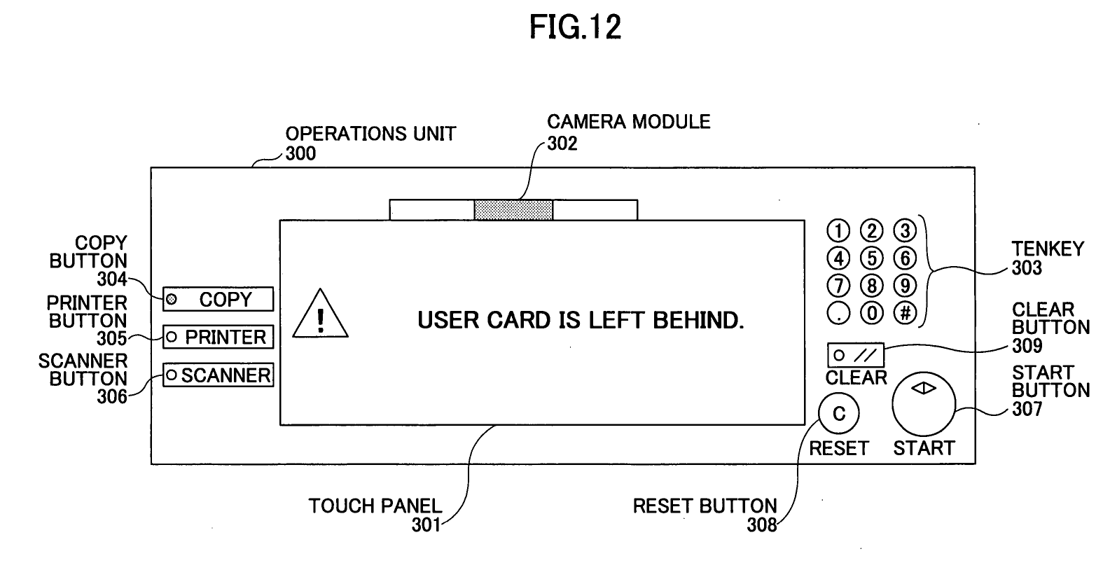

After the desired image data of the document are searched for and reprinted accordingly, the user takes the user card out of the authentication unit 218, and thus a series of steps are completed. When the user leaves the image forming device with the user card left behind in the authentication unit 218 (the facial image cannot be detected), an alert is displayed on the touch panel 301 to notify the user of the user card left behind as shown in FIG. 12. At this moment, it is more effective to use a sound (alarm) together with the alert. Therefore, according to a combination of monitoring the facial image by the camera module 302 and a conventionally well-known user card, it is possible to detect the leaving of the user with high accuracy, which is difficult for a well-known conventional human detection sensor.

In the above description, it is not necessary to input a password upon authorizing the user by the user card, but the device (not shown) may be configured to direct the user to input the password by the ten key 303 after the user card is inserted so as to improve the security. Also, in FIG. 11, the facial image icon is not shown, but the device may be configured to obtain the facial image of the user upon storing the documents so as to display the facial image icon on the touch panel 301 in FIG. 11 in the same manner as in the first embodiment. Accordingly, it is possible to further improve the security.

Moreover, in the present embodiment, it is possible to detect user's arrival and departure with high accuracy. Hence, after the user leaves the device, the entire device may be automatically switched to a power saving mode (or called standby mode) and only monitor a next user's arrival via the camera module 302. Accordingly, in comparison to a case of using the human detection sensor, it is possible to control power saving with high accuracy (less misdetection).

Furthermore, since it is possible to detect a user's arrival and departure with high accuracy in the present embodiment, the same effect can be obtained in the case of scanning the document by the scanner 101. In this case, when the user is leaving the device with the document left behind on the scanner 101, a document size sensor mounted on the scanner 101 detects presence/absence of the document so as to notify the user of the document being left behind in the same manner as in the case of the user card.

In the case where the device includes the authentication unit 218 (the second embodiment), the CPU 201 can detect the presence/absence of the user card, and read out the information in the user card. As for the authentication unit 218 and the user card, any specification can be adopted. For example, a low-cost magnetic card which is generally available may be used. Also, an IC card which costs more than the magnetic card but is difficult to be counterfeited may be used.

The camera module 302 is configured to include an optical system, an imaging device and the like which are unified. The layout of the buttons and the position where the camera module 302 is mounted are not limited to the example shown in FIG. 3.

Since the facial image of the user is input via the camera module 302 mounted above the touch panel 301, it is possible to obtain the facial image naturally without impeding a normal operation. The camera module 302 simply captures the image data, and thus does not perform processing of the image such as detection of the face. The facial image is detected and cut out by the CPU 201 executing a program stored in the HDD 204. However, in the case where a complex authorization algorithm and a complex conjuncture algorithm with large amounts of calculation are adopted, another processor exclusively for image processing may be added to the CPU 201 so as to detect and cut out the facial image.

In the image forming device according to a preferred embodiment of the present invention, a distance and a position of the face from the camera can be limited to a narrow range so that it is possible to detect the face by a comparatively simple algorithm. Since the image forming device is moved less, a background image may be obtained and stored in the information memory unit upon installing the device. The difference between the input image taken by the camera module 302 and the background image is adopted so as to reduce any adverse effect due to the background.

The cover image of the document is detected after the facial image is detected. It is reasonable to detect the facial image first since the document is often positioned within easy reach of the facial image since the document is normally held in either a right or left hand. Further, it is easier to detect a facial image than detect a document. By doing so, it is possible to determine a search region for the cover page image more properly. There are a variety of well known methods for detecting the cover image, for example, by detecting a letter region or by detecting a shape specific to a paper document (detecting a rectangle). The image forming device according to the embodiment of the present invention detects the cover page image by using either one of the methods or combining the methods.

On the other hand, data such as document box data for storing the documents, learned data of the facial images, and setting data for each of the users (for example, previously used setting data, a password, counter information of pages, etc.) are all stored in the HDD 204. If cost or capacitance permits, memory with a battery backup or flash memory may substitute for the HDD 204.

As described above, according to at least one embodiment of the present invention, the image forming device is provided with a device (camera module 302) for taking a facial image of a user so that it is effective in preventing an improper copying operation.

Further, as described above, according to at least one embodiment of the present invention, the image forming device is provided with a device for taking a facial image of a user and user authentication devices (an authentication card and an authentication unit 218) so that it becomes easier to specify the user.

Moreover, as described above, according to at least one embodiment of the present invention, the image forming device is provided with a device for taking a facial image of a user and a device for authorizing the user so that it is possible to notify the user of the user authorizing device being left behind according to the presence/absence of the facial image of the user.

Furthermore, as described above, according to at least one embodiment of the present invention, the image forming device stores the scanned document and the photographed facial image so that it becomes easy to specify the user who has performed scanning operations.

Further, as described above, according to at least one embodiment of the present invention, the image forming device is provided with a facial image similarity determination unit so that it is possible to search the documents stored in the past by using a photographed facial image.

In addition, as described above, according to at least one embodiment of the present invention, the image forming device stores the cover page image of the document and the photographed facial image so that it becomes easy to search the documents stored in the past.

Further, the present invention is not limited to these embodiments, but variations and modifications may be made without departing from the scope of the present invention.

The present application is based on Japanese Priority Application No. 2005-216938 filed on Jul. 27, 2005, and Japanese Priority Application No. 2006-071629 filed on Mar. 15, 2006, with the Japanese Patent Office, the entire contents of which are hereby incorporated by reference.

What is claimed is:

1. An image forming device for reading a document as first image data and forming an image of said first image data on a recording medium, comprising:
a reading unit optically reading said document so as to obtain said first image data;
an imaging unit taking an image of a user so as to form second image data together with a reading operation of the reading unit; and
a storage unit associating and storing the first image data read by the reading unit with the second image data of the user formed by the imaging unit.

2. The image forming device as claimed in claim 1, wherein said second image data taken by said imaging unit include facial image data of the user.

3. The image forming device as claimed in claim 2, further comprising a searching unit searching for cover image data of said document from the first image data read by said reading unit, wherein the storage unit associates and stores the first image data read by the reading unit and the facial image data of the user with the cover image data.

4. The image forming device as claimed in claim 2, further comprising:
an operations unit including a display unit; and
a detection unit detecting the facial image data of the user from said second image data taken by said imaging unit, wherein in a case where the detection unit fails to detect the facial image data, the detection unit displays an alert on said display unit.

5. A method of forming an image by reading a document as first image data and recording the first image data on a predetermined recording medium, comprising the steps of:
reading the document optically so as to obtain the first image data;
taking an image of a user so as to form second image data together with a reading operation of the document reading step; and
associating and storing the first image data of the document read by the reading unit with the second image data of the user taken by the imaging unit.

6. The method of forming an image as claimed in claim 5, wherein said second image data formed by the imaging unit include facial image data of the user.

7. The method of forming an image as claimed in claim 6, further comprising the steps of:
searching for the cover image data of the document from the first image data read out in the reading step; and
associating and storing the first image data read out in the reading step and the facial image data of the user with the cover image data.
